(19) United States
(12) Patent Application Publication
(10) Pub. No.: US 2005/0113532 A1
(43) Pub. Date: May 26, 2005

(54) High flow, toughened, weatherable polyamide compositions containing a blend of stabilizers

(76) Inventors: Robert B. Fish JR., Parkersburg, WV (US); Yefim Brun, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/997,719

(22) Filed: Nov. 23, 2004

Related U.S. Application Data
(60) Provisional application No. 60/525,263, filed on Nov. 26, 2003.

(51) Int. Cl. C08L 67/00

(52) U.S. Cl. 525/425

(57) ABSTRACT

High flow, toughened and weatherable compositions are disclosed herein, comprising 40-94 percent by weight polyamide, 6-60 percent by weight toughener (rubber or ionic copolymer), 0.1 to 10 percent by weight organic acid, and 0.3 to 10 percent by weight of a stabilizer combination (inorganic stabilizer(s) and organic stabilizer(s)). These compositions are suitable for injection molding and can be melt mixed together. Articles of manufacture so formed exhibit outstanding appearance and integrity, even after subjected to rigorous oven aging.

### CROSS REFERENCE TO RELATED APPLICATIONS

This application claims priority of U.S. provisional application Ser. No. 10/525,263, filed Nov. 26, 2003.

### FIELD OF THE INVENTION

The present invention relates to polyamide blends exhibiting high flow in molding applications and that are suitably toughened for a variety of applications, including those demanding superior performance in extreme weather conditions. More particularly, the present invention relates to such blends and articles formed therefrom, in which inorganic and organic stabilizers have been selectively introduced.

### BACKGROUND OF THE INVENTION

It is well known that toughening agents such as grafted rubbers or ionic polymers can be employed to improve the toughness of polyamides. See for example U.S. Pat. No. 4,174,358 and U.S. Pat. No. 3,845,163. It is also well known to use organic or inorganic stabilizers to decrease the loss of physical and appearance properties during exposure to heat, sunlight, and the atmosphere. Numerous additives are sold commercially for this purpose.

Types of stabilizers that are frequently present in polyamide blends are inorganic oxidative stabilizers, organic oxidative stabilizers, and organic UV light stabilizers. Representative examples of inorganic oxidative stabilizers include one or more sodium, potassium, and lithium halide salts blended with one or more of copper(I) chloride, copper(I) bromide, and copper(I) iodide. Representative examples of organic oxidative stabilizers include hindered phenols, hydroquinones, and their derivatives. Representative examples of ultraviolet light stabilizers which are frequently present in polyamide blends include various substituted resorcinols, salicylates, benzotriazoles, benzophenones, and the like. Blends of organic stabilizers or blends of inorganic stabilizers are sometimes used to achieve effective blocking of different degradation mechanisms.

It is well understood that addition of grafted rubbers or ionic polymers increases the melt viscosity of the resulting polymer blend. Moreover, the addition of an organic acid can decrease the molecular weight of the rubber toughened polyamide, imparting higher flow characteristics to the polyamide blend without adversely affecting the toughness thereof.

However, there is a need to balance the desire for higher flow characteristics with requirements for suitable oxidative and light stability, and the relative success in achieving such a balance greatly depends upon the selection of suitable stabilizers or stabilizer blends.

It is an object of the present invention to provide toughened polyamide compositions exhibiting a combination of high melt flow, good thermal stability, and good ultraviolet light stability. A further object of the invention is to provide such compositions via the incorporation of particular organic and inorganic stabilizers. It is a feature of the present invention to prepare these compositions by conventional and well-accepted methods known in the field, such as the physical blending of components, and therefore their use can be readily managed into a variety of applications. Articles made with compositions of the invention have several advantages associated therewith, among them a remarkable resilience to working environments which typically involve high temperatures. These and other objects, features and advantages of the invention as disclosed and claimed herein will become apparent upon having reference to the following description of the invention.

### SUMMARY OF THE INVENTION

There is disclosed and claimed herein high flow, toughened, heat stabilized, weatherable polyamide compositions comprising:
(a) 40-94 percent by weight polyamide;
(b) 6-60 percent by weight toughener selected from the group consisting of rubber and ionic copolymer;
(c) 0.1 to 10 percent by weight organic acid; and
(d) 0.3 to 10 percent by weight of a stabilizer combination comprising one or more inorganic stabilizers and one or more organic stabilizers.

Articles formed from the aforementioned blends are also disclosed and claimed herein.

### DETAILED DESCRIPTION OF THE INVENTION

The Polyamide (a)

Useful polyamides in conjunction with the compositions of the invention include those listed throughout the description, together with blends and copolymers thereof. Those skilled in the art will appreciate that the above described benefits are suitable for a wide range of polyamide compositions. Without intending to limit the generality of the foregoing, the following are of particular interest:

Polyamides may be selected from the group consisting of nylon-4,6, nylon-6,6, nylon-6,10, nylon-6,9, nylon-6,12, nylon-6, nylon-11, nylon-12, 6T through 12T (where “T” refers to repeat units derived from terephthalic acid), and 6I through 12I (where “I” refers to repeat units derived from isophthalic acid). Polyamides may also be formed from 2-methyl pentamethylene diamine and/or hexamethylene diamine with one or more acids selected from the group consisting of adipic acid, isophthalic acid and terephthalic acid, and blends and copolymers of all of the above.

Toughened polyamide blends may be typically characterized as having notched Izod toughness of at least about 15.0 kJ/m² (however, compositions featuring lower notched Izod values are observed as the rubber or ionomer content is decreased).

The polyamides disclosed herein are also used in blends with other polymers to produce engineering resins. The blends of this invention may also contain certain additional polymers that could partially replace the polyamide component. As used herein, these “blends” are the result of physical blending together of constituent materials to form the compositions claimed herein, as opposed to simple mixtures of such materials. Examples of such additional polymers are melamine formaldehyde, phenol formaldehyde (novolac), polyphenylene oxide (see for example EP 0 936 237 A2), polyphenylene sulfide, polysulfone and the like. These polymers can be added during the mixing step. It will be obvious to those skilled in the art that the present invention relates to modification of the polyamide component and that additional polymers could be added appropriately without departing from the spirit and scope of this present invention.

A commercially available, toughened polyamide with good thermal stability and good ultraviolet light stability is ZYTEL® ST801W BK195, sold commercially by E. I. DuPont de Nemours & Co., Inc., Wilmington, Del.

The Toughener (b)

Rubber-toughened polyamide compositions have been commercially available for more than twenty years. The technology involves incorporating an olefinic rubber in the polyamide. This is often done in the melt phase. The rubber dispersion must be fairly stable, i. e., the rubber phase must not coalesce substantially during subsequent melt processing such as injection molding. Since olefinic rubbers are incompatible with polyamides, it is necessary to modify the rubber with functional groups that are capable of reacting with the acid or amine ends in the polyamide polymer. The reaction of an anhydride with an amine is very fast; therefore, an anhydride is often the functionality of choice. When an incompatible olefinic rubber with anhydride functionality is mixed with a polyamide, the anhydride functionality of the rubber reacts with the amine ends of the polyamide resulting in the rubber becoming grafted on the polyamide molecule. This molecular bonding minimizes coalescence of the rubber phase.

The use of ionic copolymers to produce toughened nylon blends is well known in the art. See for example U.S. Pat. No. 3,845,163 which discloses blends of nylon and ionic copolymers. Further, U.S. Pat. No. 5,688,868 discloses the preparation of such toughened blends wherein the ionic copolymer is prepared in-situ with very high levels of neutralization. U.S. Pat. No. 5,091,478 discloses flexible thermoplastic blends wherein the nylon component may be between 25 and 50 volume % with the polyamide comprising at least one continuous phase of the composition. Finally, U.S. Pat. No. 5,866,658 covers ionomer/polyamide blends in the range 40-60 weight percent ionomer and 60-40 weight percent polyamide. The present invention may be applied to the types and ranges of ionic copolymers as disclosed therein, and accordingly each of these patents is incorporated by reference.

Representative tougheners useful in the practice of this invention include many branched and straight chain polymers and block copolymers and mixtures thereof. These are represented by the formula:
A₍ₐ₎-B_{(b)}-C_{(c)}-D_{(d)}-E₍ₑ₎-F_{(f)}-G_{(g)}-H₍ₕ₎
derived in any order, e.g., random, from monomers A to H where
A is ethylene;
B is CO;
C is an unsaturated monomer taken from the class consisting of a β-ethylenically unsaturated carboxylic acids having form 3 to 8 carbon atoms, and derivatives thereof taken from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions and dicarboxylic acids and monoesters of the dicarboxylic acid neutralized by amine-ended caprolactain oligomers having a DP to 6 to 24;
D is an unsaturated epoxide of 4 to 11 carbon atoms;
E is the residue derived by the loss of nitrogen from an aromatic sulfonyl azide substituted by carboxylic acids taken from the class consisting of monocarboxylic and dicarboxylic acids having from 7 to 12 carbon atoms and derivatives thereof taken from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having form 0 to 100 percent of the carboxylic acid groups ionized by neutralization with metal ions;
F is an unsaturated monomer taken form the class consisting of acrylates esters having form 4 to 22 carbons atoms, vinyl esters of acids having form 1 to 20 carbon atoms (substantially no residual acid), vinyl ethers of 3 to 20 carbon atoms, and the vinyl and vinylidene halides, and nitriles having from 3 to 6 carbon atoms;
G is an unsaturated monomer having pendant hydrocarbon chains of 1 to 12 carbon atoms capable of being grafted with monomers having at least one reactive group of the type defined in C, D and E, and pendant aromatic groups which my have 1 to 6 substituent groups having a total of 14 carbon atoms; and
H is an unsaturated monomer taken from the class consisting of branched, straight chain and cyclic compounds having from 4 to 14 carbon atoms and at least one additional nonconjugated unsaturated carbon-carbon bond capable of being grafted with a monomer having at least one reactive group of the type defined in C, D and E.

The aforementioned monomers may be present in the polymer in the following mole fraction:
(a) 0 to 0.95;
(b) 0 to 0.3;
(c) 0 to 0.5;
(d) 0 to 0.5;
(e) 0 to 0.5;
(f) 0 to 0.99;
(g) 0 to 0.99; and
(h) 0 to 0.99
   so that the total of all components is a mole fraction of 1.0.

Preferably (a) to (h) are present in the following mole fraction:
(a) 0 to 0.9;
(b) 0 to 0.2, most preferably 0.1 to 0.2
(c) 0.0002 to 0.2 most preferably 0.002 to 0.05;
(d) 0.005 to 0.2, most preferably 0.01 to 0.1;
(e) 0.0002 to 0.1, most preferably 0.002 to 0.01;
(f) 0 to 0.98;
(g) 0 to 0.98; and
(h) 0 to 0.98

The Organic Acid (c)

Any number of organic acids may be selected. Organic acids are organic compounds of C, H, and O containing one or more carboxylic acid functionalities. Examples of suitable organic acids include adipic acid, pimelic acid, suberic acid, azelaic acid, sebacic acid, undecanedioic acid, and dodecanedioic acid (all dicarboxylic acids); and, valeric acid, trimethylacetic acid, caproic acid, and caprylic acid (all monocarboxylic acids). Dodecanedioic acid (“DDDA”) is of particular interest.

The Stabilizer Combination (d)

The blends of this invention contain a stabilizer package, comprising one or more inorganic stabilizers in combination with one or more organic stabilizers. The use of inorganic stabilizer blends is well known in the art. See, for example, Nylon Plastics Handbook by M. I. Kohan, page 442-443 (1985) discusses the use of a blend of copper salts to improve stability during air aging.

The use of organic stabilizer blends is also well known. In addition to Kohan (op. cit.), Pub. No. 016529.00.040 by Ciba Specialty Chemicals C 2003 lists an extensive number of organic additives for light stability, processing and thermal stability and blends thereof.

Types of stabilizers that are frequently present in polyamide blends are inorganic oxidative stabilizers, organic oxidative stabilizers, and organic UV light stabilizers. Representative examples of inorganic oxidative stabilizers include one or more sodium, potassium, and lithium halide salts blended with one or more of copper(I) chloride, copper(I) bromide, and copper(I) iodide. Representative examples of organic oxidative stabilizers include hindered phenols, hydroquinones, and their derivatives. Representative ultraviolet light stabilizers which are frequently present in polyamide blends include various substituted resorcinols, salicylates, benzotriazoles, benzophenones, and the like. The resulting blends and compositions of this invention are suitably stabilized to demonstrate superior weatherability and thermal stability.

In a preferred embodiment of the invention, the polyamide compositions comprise 70-90 weight percent polyamide, 10-30 weight percent of the toughener, 0.1 to 1 weight percent of organic acid, 0.5 to 1.5 weight percent of the stabilizer combination and 1-3% carbon black colorant added as a concentrate. In the most preferred embodiment of the invention, the polyamide compositions comprise 75-80 weight percent polyamide, 10-20 weight percent of the toughener, 0.5 to 0.65 weight percent of organic acid, 0.5 to 1.0 weight percent of the stabilizer combination and 2% carbon black colorant added as a concentrate.

There is also disclosed and claimed herein processes for the preparation of toughened polyamide compositions exhibiting high flow and toughness, comprising melt-mixing in a conventional extruder 40-94 percent by weight polyamide, 6-60 percent by weight toughener selected from the group consisting of rubber and ionic copolymer, 0.1 to 10 percent by weight organic acid, and 0.3 to 10 percent by weight of a stabilizer combination.

The claimed compositions are highly amenable to a variety of processing techniques. These include but are not limited to, mixing the ingredients together in a high intensity mixer such as a twin screw extruder; taking a product with no high flow attributes and adding in dodecanedioic acid and then injection molding the resulting composition according to conventional techniques known in the field; and blending all ingredients (except the dodecanedioic acid) and feeding them into an injection molding machine, then adding the acid and heat stabilizers as a second step.

There are many process variations contemplated herein. For example, the polyamide, toughener and organic acid may be melt-mixed as one step; a blend of polyamide and toughener may be melt-mixed with the acid; or polyamide and toughener may be blended and subsequently melt-mixed with the acid. Further, melt mixing may be effected by extrusion or molding alone or in combination.

The blends of this invention may also contain one or more conventional additives such as lubricants and mold release agents, colorants including dyes and pigments, flame-retardants, plasticizers, and the like. These additives are commonly added during the mixing step. They may be added in effective amounts as is readily appreciated by those having skill in the art. Representative lubricants and mold release agents include stearic acid, stearyl alcohol, and stearamides. Representative organic dyes include nigrosine, while representative pigments include titanium dioxide, cadmium sulfide, cadmium selenide, phthalocyanines, ultramarine blue, carbon black, and the like. Representative flame-retardants include organic halogenated compounds such as decabromodiphenyl ether, brominated polystyrene, poly(brominated styrene) and the like. The toughener can be used in neat or diluted form. In the latter case, EPDM, EPR, or polyethylene can be used as the diluent.

The compositions herein are suitable towards a variety of applications and end uses. Without intending to limit the generality of the foregoing, exterior surface components of automobiles such as roof racks benefit from increased durability and under a wide range of weather and temperature conditions. The instant compositions as applied towards such applications offer significant benefits in longevity and performance of such parts.

The invention will become better understood upon having reference to the examples herein. In Tables 1,3, and 7 the numbers listed are expressed in weight percent based on total weight of composition. In Table 5 the numbers listed are expressed in weight fraction based on total weight of composition. Tables 2, 4, 6, and 8 contain vital data as will be best understood upon having reference to the descriptions accompanying each table.

### EXAMPLES

Analytical Procedures

Polymer melt viscosity. Polymer melt viscosity may be measured using a commercial viscosity-measuring machine such as the Kayeness Melt Viscometer. Viscosity is measured at a shear rate of 1,000 sec-1 and at a temperature of 280° C.

Thermal stability by percent retention of notched Izod. Thermal stability may be evaluated by the air oven aging test (hereinafter designated, “AOA”). (ISO 188) using condition H5 (1,000 hours at 110° C.). In each case, samples were molded on an injection molding machine into ISO test bars, notched, and exposed to air in an oven for 1,000 hours at 110° C. The notched Izod impact resistance of the bars was then measured and compared with that of control bars made from the same material that were tested as molded. Notched Izod toughness were determined in accordance with ISO 527-2C at room temperature and a 4 mm thick×80 mm in length specimen. Exposed bars that retained at least 75% of the notched Izod impact resistance of the unexposed bars were deemed to have acceptable thermal stability.

Thermal stability by retention of number average molecular weight. Thermal stability may also be evaluated by determining the number average molecular weight (hereinafter, Mn) of the polyamide portion of the blend after air oven aging exposure. The use of Mn to evaluate polymer stability is well known to those skilled in the art. See, for example, API Technical Report 17TR2 (American Petroleum Institute, June 2003). To perform this analysis, pellet samples placed in a small glass beaker were exposed, again using the exposure conditions in Condition H5 of ISO 188 (1,000 hours at 110° C.). The Mn of the samples after exposure was reported.

Molecular weight distribution and average molecular weights of the polyamide portion of the blend may be measured using a commercial multidetection size exclusion chromatography (SEC) instrument such as an Alliance™ 2690 from Waters Corp., Milford, Mass., equipped with a commercial differential refractive index spectrophotometer, differential capillary viscometer and static light scattering photometer such as a TDA 301™ on-line triple detection array from Viscotek Corp., Houston, Tex. A polymer sample is dissolved in 1,1,1,3,3,3-hexafluoro-2-propanol (HFIP) containing 0.01M sodium trifluoroacetate, which also may be used as a mobile phase. Size-exclusion separation may be performed with commercial SEC columns such as Shodex HFIP-80M styrene-divinyl benzene columns with an exclusion limit 2×10⁷ and 8,000/30 cm theoretical plates.

A sample of ZYTEL® 101, a commercially available nylon 6,6 from E. I. DuPont de Nemours & Co., Inc. (Wilmington, Del.) is dissolved in HFIP at a concentration of 2 mg/ml and subjected to multidetection SEC analysis using the triple detection system described above. Molecular weight distribution (MWD) of said sample was calculated from the collected chromatograms using commercial SEC data reduction software Trisec™ Triple Detector SEC3 version 3.0 by Viscotek Corp.

A 3^{rd} order molecular weight calibration curve was calculated for a set of two Shodex HFIP-80M columns using cumulative matching method from the MWD.

Each toughened polyamide-based composite was dissolved in HFIP (8 mg in 4 ml solvent) during 4 hours at room temperature with continuous moderate agitation using automatic sample preparation system PL 260 TM from Polymer Laboratories, Church Stretton, UK. Undissolved material was removed by filtration through a 0.45 micron TFEE membrane with 5 cm Whatman filter paper disc placed over it. 0.1 ml of dissolved sample was injected into the triple detection SEC system described above and equipped with two calibrated columns. Number-average molecular weight, Mn, was calculated using refractive index detector chromatogram and said molecular weight calibration curve.

Ultraviolet light stability. Ultraviolet light stability may be evaluated by the accelerated aging in a commercial weathering machine subject to 2,500 kJ/m2. (SAE J1960, Jun 1989). This technique is largely considered the definitive standard for exterior weathering evaluation, and involves exposure to a variety of climate conditions including light, heat and water exposure. For these tests the additional sample washing requirements in General Motors Engineering Standard GMP.PA66.074 (June 1999) were also applied. The performance of compositions in the ultraviolet light stability test is the primary indicator of their “weatherability” for purposes of this invention, and define an important attribute of compositions of the present invention. A “Delta-E” of 3.0 or less, calculated in accordance with these two standards, is acceptable.

### Comparative Examples 1-2

Comparative Example 1 illustrates the preparation of a highly rubber-toughened, weatherable polyamide. ZYTEL® 101 is a 66-nylon, commercially available from E. I. DuPont and Nemours & Co., Inc., Wilmington, Del. Fusabond N MF521D is a grafted EPDM elastomer with maleic anhydride functionality and is also commercially available from DuPont. The stabilizers used in Comparative Example 1 are a physical blend of Irgafos® 168 and Tinuvin® 770, both organic stabilizers that are available commercially from Ciba Specialty Chemicals, Tarrytown, N.Y. Irgafos® 168 is an organic oxidative stabilizer, while Tinuvin® 770 is an organic ultraviolet light stabilizer. The black color concentrate is a fine particle size carbon black dispersed by extrusion blending into a suitable carrier. In these cases the blend was 25% carbon black and 75% methyl acrylate polymer, both percentages by weight. Dodecanedioic acid is also available commercially from DuPont. Aluminum distearate could also be obtained from Ciba Specialty Chemicals.

During the operation for melt blending the ingredients were primarily fed through individually controlled loss in weight feeders. However, for ease and control of feeding, the nylon and the low percentage additive ingredients were first dry blended by tumbling in a drum. The mixture was then compounded by melt blending in a 57 mm Werner & Pfleiderer co-rotating twin screw extruder with a barrel temperature about 270° C. and a die temperature of about 280° C. All the ingredients were fed into the first barrel section except for about half the nylon feed, which was fed into the sixth barrel section by use of a sidefeeder. Extrusion was carried out with a port under vacuum. The screw speed was 250 rpm and the total extruder feed rate was 175 pounds per hour. The resulting strand was quenched in water, cut into pellets, and sparged with nitrogen until cool.

In this case, the ingredients were melt blended in the quantities shown in Table 1.

The resin was checked to insure moisture was between 0.1% and 0.2% and was then molded into test bars and test plaques. This material is Comparative Example 1.

A similar material using the aforementioned high flow technology was formed by replacing 0.65% of the nylon with an equal amount of the organic acid dodecanedioic acid to make Comparative Example 2. Using the same extruder conditions as in Comparative Example 1 and a rate of 300 lb/hr, the melt temperature during extrusion was 314° C. The polymer strands coming from the extruder were quenched in water and fed into a cutter. The hot pellets were collected in a vessel that was continuously swept with nitrogen gas. In this case, the ingredients were melt blended in the quantities shown in Table 1:

TABLE 1

| | Comparative | Comparative |
|---|---|---|
| | Example 1 | Example 2 |
| ZYTEL ® 101 | 77.4 | 77.75 |
| Fusabond ® N | 15.8 | 15.8 |
| MF521D | | |
| Black color | 5.7 | 5.7 |
| concentrate | | |
| Dodecanedioic Acid | 0.0 | 0.65 |
| Irgafos ® 168 | 0.5 | 0.5 |
| Tinuvin ® 770 | 0.5 | 0.5 |
| Aluminum Distearate | 0.1 | 0.1 |

The moisture in the resulting pellets was adjusted to between 0.1 and 0.2 weight percent by drying or adding additional water as required. Test bars were molded in an injection molding machine according to ISO methods. Test results are shown in Table 2

The thermal stability by number average molecular weight was also evaluated by exposing pellets to air in an oven at 110° C. for 1,000 hours. The number average molecular weight was measured and is reported in Table 2

TABLE 2

| | Comparative | Comparative |
|---|---|---|
| | Example 1 | Example 2 |
| Mn after air oven aging | | 5,150 |
| Melt Viscosity, Pa-S | | 98 |
| Retention of notched Izod | | 12.3% |
| after air oven aging, % | | |
| Ultraviolet light stability | | 2.95 |

Both Comparative Examples 1 and 2 use the same levels of an organic oxidative stabilizer and an organic ultraviolet light stabilizer. The addition of 0.65% organic acid in Comparative Example 2 results in higher flow (lower melt viscosity). Also suitable UV light stability is maintained. However, the stabilizer combination does not also maintain air oven stability, as indicated by the poor retention of notched Izod impact resistance after air oven aging and the low Mn after air oven aging. While the ultraviolet light stability was within the acceptable range, this material does not meet the dual requirement of good ultraviolet light stability and good retention of properties after air oven aging.

### Comparative Examples 3-6

Various amounts of stabilizer are used in an attempt to simultaneously balance the combined properties of air oven stability and ultraviolet light stability.

In Comparative Examples 3-6 various combinations of organic oxidative and UV light stabilizers are used. Tinuvin® 144 and Irganox® 1098 are organic UV stabilizers and antioxidants respectively, and are commercially available from Ciba Specialty Chemicals. Cyasorb® UV3346 is an organic UV stabilizer commercially available from Cytec Industries, West Paterson, N.J.

The materials were melt-blended as before, using in these cases the recipes shown in Table 3.

TABLE 3

| | Compa- | Compa- | Compa- | Compa- |
|---|---|---|---|---|
| | rative | rative | rative | rative |
| | Example 3 | Example 4 | Example 5 | Example 6 |
| ZYTEL ® 101 | 76.85% | 76.85% | 76.85% | 76.85% |
| FUSABOND ® N | 15.8% | 15.8% | 15.8% | 15.8% |
| MF521D | | | | |
| Black color | 5.70% | 5.70% | 5.70% | 5.70% |
| Dodecanedioic Acid | 0.65% | 0.00% | 0.65% | 0.00% |
| fed in Barrel 1 | | | | |
| Dodecanedioic Acid | 0.00% | 0.65% | 0.00% | 0.65% |
| fed in Barrel 6 | | | | |
| Irganox ® 245 | 0.50% | 0.00% | 0.00% | 0.25% |
| Cvasorb ® UV3346 | 0.25% | 0.00% | 0.00% | 0.00% |
| Tinuvin ® 144 | 0.25% | 0.50% | 0.50% | 0.50% |
| Irganox ® 1098 | 0.00% | 0.25% | 0.25% | 0.25% |
| Tinuvin ® 770 | 0.00% | 0.25% | 0.25% | 0.00% |

The moisture content of samples from each of these Comparative Examples were adjusted to be between 0.1 and 0.2 weight percent by drying or adding additional water as required. Test bars were molded in an injection molding machine according to ISO methods. The molded bars were tested using the following test procedures in their dry-as-molded state. The data are shown in Table 4.

The thermal stability by number average molecular weight was also evaluated by exposing pellets in an air over at 110° C. for 1,000 hours.

TABLE 4

| | Comparative | Comparative | Comparative | Comparative |
|---|---|---|---|---|
| | Example 3 | Example 4 | Example 5 | Example 6 |
| Mn after air | 6,160 | 4,750 | 5,060 | 5,940 |
| oven aging | | | | |
| Melt viscosity, | 98 | 98 | 80 | 94 |
| Pa-S | | | | |
| Retention of | 33.9% | 12.4% | 9.7% | 9.6% |
| notched Izod | | | | |
| after air | | | | |
| oven aging, % | | | | |
| Ultraviolet | 1.52 | 2.95 | 2.98 | 1.57 |
| light stability | | | | |

Comparative Examples 3-6 show that even after evaluating a wide variety of combinations of organic oxidative stabilizers together with ultraviolet light stabilizers, a resin that meets both requirements for air oven stability and ultraviolet light stability is difficult to achieve. In addition, the Mn after heat aging is also low.

### Examples 1-2

In these cases, a mixed stabilizer consisting of both an inorganic and organic portion was employed. The materials were melt-blended as before, using in these cases the recipes shown in Table 5. Irganox® 245 is ethylenebis(oxyethylene)bis-3(5-tert-butyl4-hydroxy-m-tolyl)-propionate, an organic phenolic antioxidant available commercially from Ciba Specialty Chemicals. Tinuvin® 234 is 2(2H-benzotriazol-2-yl)-4,6-bis(1-methyl-1-phenylethyl)phenol, an organic benzotriazole UV absorber available commercially from Ciba Specialty Chemicals. HS711 is an inorganic oxidative stabilizer comprising a physical blend of 7 parts cuprous iodide, 1 part potassium iodide, and 1 is part aluminum distearate.

TABLE 5

| | Example 1 | Example 2 |
|---|---|---|
| ZYTEL ® 101 | 0.769 | 0.769 |
| EPDM grafted | 0.080 | 0.080 |
| with maleic | | |
| anhydride | | |
| Engage ® 8180 | 0.078 | 0.078 |
| (commercially | | |
| available from | | |
| DuPont Dow | | |
| Elastomers) | | |
| Black color | 0.057 | 0.057 |
| concentrate | | |
| Dodecanedioic | 0.0065 | 0.0065 |
| Acid | | |
| Tinuvin ® 234 | 0.005 | 0 |
| HS711 | 0.0025 | 0.0025 |
| Irganox ® 1010 | 0.0025 | 0 |
| Irganox ® 1098 | 0 | 0.0025 |
| Irganox ® 245 | 0 | 0.005 |

The moisture content of samples from each of these Comparative Examples were adjusted to be between 0.1 and 0.2 weight percent by drying or adding additional water as required. Test bars were molded in an injection molding machine according to ISO methods. The molded bars were tested using the following test procedures in their dry-as-molded state. The data are shown in Table 6.

Additionally, the thermal stability by number average molecular weight was evaluated by exposing pellets in an air over at 110° C. for 1,000 hours. The number average molecular weight was measured after exposure and is shown in Table 6.

TABLE 6

| | Example 1 | Example 2 |
|---|---|---|
| Mn after air oven aging | 8,370 | 8,000 |
| Melt Viscosity, Pa-S | 121 | 113 |
| Retention of notched Izod | 115 | 96 |
| after air oven aging, % | | |
| Ultraviolet light stability | 1.13 | 1.61 |

In the case of Example 1, three stabilizers are used: Tinuvin® 234, HS71 1, and Irganox® 1010 (the latter available from Ciba Specialty Chemicals) which are, respectively an organic ultraviolet light absorber, an inorganic oxidative stabilizer, and an organic oxidative stabilizer. Similarly, in the case of Example 2, three stabilizers are also used: HS711, Irganox® 1098, and Irganox® 245. HS711 is an inorganic oxidative stabilizer and both Irganox® additives are organic oxidative stabilizers.

It can be readily observed this combination of stabilizers produces a resin with high melt flow, good retention of Mn after heat aging, good retention of notched Izod after heat aging, and good ultraviolet light stability.

### Examples 3-5

In these cases, a mixed stabilizer consisting of both an inorganic and organic portion was employed. The materials were melt-blended as before, using in these cases the recipes shown in Table 7.

TABLE 7

| | Example 3 | Example 4 | Example 5 |
|---|---|---|---|
| Aluminum | 0.1 | 0.1 | 0.1 |
| Distearate | | | |
| Dodecanedioic Acid | 0.65 | 0.65 | 0.65 |
| Black color | 5.7 | 5.7 | 5.7 |
| concentrate | | | |
| Fusabond ® N | 15.8 | 15.8 | 15.8 |
| MF521D | | | |
| HS711 | 0.1 | 0.25 | 0.25 |
| Irgafos ® 168 | 0.4 | 0 | 0 |
| Irganox ® 1010 | 0 | 0 | 0.25 |
| Irganox ® 1098 | 0 | 0.25 | 0 |
| Irganox ® 245 | 0.5 | 0 | 0.5 |
| Tinuvin ® 234 | 0 | 0.5 | 0 |
| ZYTEL ® 101 | 76.75 | 76.75 | 76.75 |
| TOTAL | 100 | 100 | 100 |

The moisture content of samples from each of these Comparative Examples were adjusted to be between 0.1 and 0.2 weight percent by drying or adding additional water as required. Test bars were molded in an injection molding machine according to ISO methods. The molded bars were tested using the following test procedures in their dry-as-molded state. The data are shown in Table 8.

TABLE 8

| | Example 3 | Example 4 | Example 5 |
|---|---|---|---|
| Mn after air oven aging | 18,300 | 17,700 | 18,200 |
| Melt Viscosity, Pa-S | 154 | 137 | 132 |
| Retention of notched Izod | | | |
| after air oven aging, % | | | |
| Ultraviolet light stability | 1.7 | 0.3 | 2.3 |

It can be readily observed this combination of stabilizers produces a resin with high melt flow, good retention of Mn after heat aging, and good ultraviolet light stability.

1. A high flow, toughened, heat stabilized weatherable polyamide composition comprising:
a) 40-94 percent by weight polyamide;
b) 6-60 percent by weight toughener selected from the group consisting of rubber and ionic copolymer;
c) 0.1 to 10 percent by weight organic acid; and
d) 0.3 to 10 percent by weight of a stabilizer combination comprising one or more inorganic stabilizers and one or more organic stabilizers.

2. The composition of claim 1 wherein said polyamide (a) is selected from the group consisting of nylon-4,6, nylon-6,6, nylon-6,10, nylon-6,9, nylon-6,12, nylon-6, nylon-11, nylon-12, 6T through 12T, 6I through 12I, polyamides formed from 2-methylpentamethylene diamine and/or hexamethylene diamine with one or more acids selected from the group consisting of adipic acid, isophthalic acid and terephthalic acid, and blends and copolymers of said nylons and polyamides thereof.

3. The composition of claim 1 wherein said organic acid (c) is selected from the group consisting of adipic acid, pimelic acid, suberic acid, azelaic acid, sebacic acid, undecanedioic acid, dodecanedioic acid, valeric acid, trimethylacetic acid, caproic acid, and caprylic acid.

4. The composition of claim 3 wherein said organic acid (c) is dodecanedioic acid.

5. A process for the preparation of toughened polyamide compositions exhibiting high flow and toughness, comprising melt-mixing 40-94 percent by weight polyamide, 6-60 percent by weight toughener selected from the group consisting of rubber and ionic copolymer, 0.1 to 10 percent by weight organic acid, and 0.3 to 10 percent by weight stabilizer combination comprising one or more inorganic stabilizers and one or more organic stabilizers.

6. The process of claim 5 wherein said polyamide, said toughener, said organic acid, and said stabilizer combination are melt-mixed in one step.

7. The process of claim 5 wherein a blend of said polyamide and said toughener is melt-mixed with said organic acid and said stabilizer combination.

8. The process of claim 5 wherein said polyamide and said toughener are blended and said organic acid and said stabilizer combination are subsequently melt-mixed therewith.

9. The process of claim 5 wherein said melt-mixing is accomplished by one or both of extrusion and molding.

10. The composition of claim 1 having an ultraviolet light stability as measured by SAE J1960, Jun 1989 that is maintained with a Delta-E of 3.0 or less after exposure to 2,500 kJ/m² and the polyamide has a number average molecular weight which is maintained above 7,500 after exposure to air for 1,000 hr at 110° C.

11. The composition of claim 1 having an ultraviolet light stability as measured by SAE J1960, Jun 1989 that is maintained with a Delta-E of 3.0 or less after exposure to 2,500 kJ/m² and further wherein the composition has a notched Izod impact resistance of which at least 75% is maintained after exposure to air for 1,000 hr at 110° C.

12. The composition of claim 1 wherein at least one stabilizer is an inorganic oxidative stabilizer and at least one stabilizer is an organic oxidative stabilizer.

13. The composition of claim 12 further comprising an organic ultraviolet stabilizer.

14. An article of manufacture formed from the blend of claim 1.
